(19) United States
(12) Patent Application Publication
(10) Pub. No.: US 2009/0125871 A1
(43) Pub. Date: May 14, 2009

(54) SYSTEM AND METHOD FOR MAKING PHOTOMASKS

(76) Inventors: Thomas J. Aton, Dallas, TX (US); Carl A. Vickery, Garland, TX (US)

Correspondence Address: TEXAS INSTRUMENTS INCORPORATED, P O BOX 655474, M/S 3999, DALLAS, TX, 75265, US

(21) Appl. No.: 11/940,245

(22) Filed: Nov. 14, 2007

(51) Int. Cl. G06F 17/50

(52) U.S. Cl. 716/21; 716/19

(57) ABSTRACT

The present disclosure is directed a method for, preparing a photomask pattern. The method comprises receiving drawn pattern data from a design database. The drawn pattern data describes two or more adjacent feature ends that are positioned at different locations along a y-axis. A photomask pattern is formed for patterning the feature ends, wherein the photomask pattern will result in the feature ends being positioned at the same location along the y-axis.

### FIELD OF THE DISCLOSURE

The present disclosure relates generally to the field of photolithography, and more specifically to a method and system for preparing a pattern for a photomask.

### BACKGROUND OF THE DISCLOSURE

Conventional optical projection lithography has been the standard silicon patterning technology for the past 20 years. It is an economical process due to its inherently high throughput, thereby providing a desirable low cost per part or die produced. A considerable infrastructure (including steppers, photomasks, resists, metrology, etc.) has been built up around this technology.

In this process, a photomask, or “reticle”, includes a semiconductor circuit layout pattern typically formed of opaque chrome, on a transparent glass (typically SiO₂) substrate. A stepper includes a light source and optics that project light coming through the photomask to image the circuit pattern, typically with a 4× to 5× reduction factor, on a photo-resist film formed on a substrate. The term “chrome” refers to an opaque masking material that is typically but not always comprised of chrome. The transmission of the opaque material may also vary such as in the case of an attenuating phase shift mask.

The process of making the photomask begins by receiving data from a design database. The design database contains data describing at least a portion of an integrated circuit design layout, referred to as the “drawn” pattern, which generally provides a target pattern that the designers wish to achieve on the substrate. Techniques for forming design databases are well known in the art.

After receiving the design database, mask makers form one or more photomasks that can be used to implement the target pattern described by the design data. This mask making process may generally include generating mask pattern data describing initial photomask patterns for forming device features. The initial photomask patterns are formed by employing various resolution enhancement techniques. The resolution enhancement techniques can include splitting the drawn pattern so that it is patterned using two or more photomasks, such as a phase shift mask and a trim mask, for use in a phase shift process (altPSM). Methods for forming phase and trim patterns from design data are well known in the art.

After the initial photomask patterns are formed, a proximity correction process is carried out that corrects the mask pattern data for proximity effects. The proximity correction process generally involves running proximity correction software to perform calculations that alter the shape of the initial photomask pattern to take into account proximity effects, such as optical diffraction effects that occur during the imaging process. In this method, a computer simulation program is often used to compute image-like model values that are taken to represent the features formed for a particular photomask feature pattern or group of patterns. Based on these simulated model values, the photomask pattern can be altered and then simulated again to determine if the altered pattern will improved the printed features. This process can be repeated until the result is with desired specifications. The features added to a photomask pattern based on this procedure are called optical proximity correction features.

After proximity correction has been performed, verification of the mask pattern data can be performed. The verification process can involve checking the final mask patterns against the desired circuit as specified in the drawn database, including any modifications to the drawn database made during the mask making process. Thus, any modifications made to the drawn pattern during the mask making process may be fed forward to a verification database so that verification can occur. After the verification process is complete, the mask pattern data can then be sent to a mask shop, where the actual photomasks are fabricated from the mask pattern data.

As device features continue to shrink, it has become more and more difficult for mask makers to form photomask patterns that can implement the target patterns contained in the design database. These difficulties are generally due to spatial bandwidth constraints of modern lithography systems, and the inherent difficulties associates with forming patterns approaching a nanometer scale (e.g., such as patterns having a critical dimension of 90 nm or less). In the past, these problems have been dealt with by setting appropriate design rules that designers can follow to form a design having target patterns that can be successfully implemented. However, the design rules have become increasingly complex, and often result in complicated patterns in the target design that are difficult or impossible to implement.

Given the overly complicated patterns formed by designers, mask makers might decide to redraw the target patterns to allow them to be implemented, while still maintaining the intended functionality of the circuit design. However this can be a difficult and time consuming process due to the enormous amount of data that must be culled through by the mask makers. Accordingly, a method for more efficiently forming target patterns that can be implemented would be a desirable improvement in the mask manufacturing process.

### SUMMARY OF THE DISCLOSURE

In accordance with the disclosure, an embodiment of the present teachings is directed a method for preparing photomask patterns. The method comprises receiving drawn pattern data from a design database, the drawn pattern data describing a feature having a first target pattern. The first target pattern for the feature is positioned so as not to be patternable with a major mask pattern edge by a first distance. It is determined whether the first distance will result in a significant risk of patterning error. If it is determined that there is a significant risk of patterning error, the first target pattern is modified to form a second target pattern that will reduce the risk of patterning error. If it is determined that there is not a significant risk of patterning error, the first target pattern can be maintained.

Another embodiment of the present disclosure is directed to a multi-pattern process for patterning an integrated circuit device. The process comprises providing a substrate and forming a layer on the substrate. A first photoresist is applied over the layer and exposed to radiation through a first photomask. The first photoresist is developed to form a first pattern. The first pattern is transferred into the layer by etching. The first photoresist is removed and a second photoresist is applied over the layer. The second photoresist is exposed to radiation through a second photomask and developed to form a second pattern. The second pattern is transferred into the layer by etching and the second photoresist is removed. At least one of the first and second photomasks are prepared by a method comprising: receiving drawn pattern data for a design database, the drawn pattern data describing a gate feature end, wherein a first target pattern for the gate feature end is positioned so as not to be patternable with a major mask pattern edge by a first distance; and modifying the first target pattern to form a second target pattern that will reduce the risk of patterning error.

Another embodiment of the present disclosure is directed to a method for preparing a photomask pattern. The method comprises receiving drawn pattern data from a design database. The drawn pattern data describes two or more adjacent feature ends that are positioned at different locations along a y-axis. A photomask pattern is formed for patterning the feature ends, wherein the photomask pattern will result in the feature ends being positioned at the same location along the y-axis.

Additional objects and embodiments of the disclosure will be set forth in part in the description which follows, and can be learned by practice of the disclosure. It is to be understood that both the foregoing general description and the following detailed description are exemplary and explanatory only and are not restrictive of the disclosure, as claimed.

### BRIEF DESCRIPTION OF THE DRAWINGS

The accompanying drawings, which are incorporated in and constitute a part of this specification, illustrate several embodiments of the disclosure and, together with the description, serve to explain the principles of the disclosure.

FIG. 1 illustrates a system for forming a photomask pattern, according to an embodiment of the present disclosure.

FIG. 2 illustrates a flow diagram of a process for making photomasks, according to an embodiment of the present disclosure.

FIG. 3 illustrates one example of drawn pattern data for a drawn circuit layout of a gate level pattern, according to an embodiment of the present disclosure.

FIG. 4 depicts a top view of an exemplary photomask pattern that may be used in conjunction with a second photomask pattern for implementing the drawn pattern of FIG. 3, according to an embodiment of the present disclosure.

FIG. 5 illustrates a hardmask made using the phase pattern of FIG. 4, according to an embodiment of the present disclosure.

FIGS. 6A, 7A and 8A illustrate various trim mask patterns, according to embodiments of the present application.

FIGS. 6B, 7B and 8B illustrate hard mask patterns formed using the trim mask patterns of FIGS. 6A, 7A and 8A, respectively, according to embodiments of the present application.

FIG. 9 illustrates a drawn pattern for a gate level circuit layout, according to an embodiment of the present disclosure.

FIG. 10 illustrates a hardmask pattern formed using a first photomask, according to an embodiment of the present disclosure.

FIGS. 11 and 12A illustrate two different trim mask patterns that can be used in conjunction with a first photomask that was used to form the hardmask of FIG. 10, according to an embodiment of the present disclosure.

FIG. 12B illustrates a hardmask pattern of FIG. 10 as it has been altered using the trim masks of FIGS. 11 and 12A, according to an embodiment of the present disclosure

FIG. 13 illustrates a disclosed 2p/2e process, according to an embodiment of the present disclosure.

### DESCRIPTION OF THE EMBODIMENTS

Reference will now be made in detail to various exemplary embodiments of the present disclosure, examples of which are illustrated in the accompanying drawings. Wherever possible, the same reference numbers will be used throughout the drawings to refer to the same or like parts.

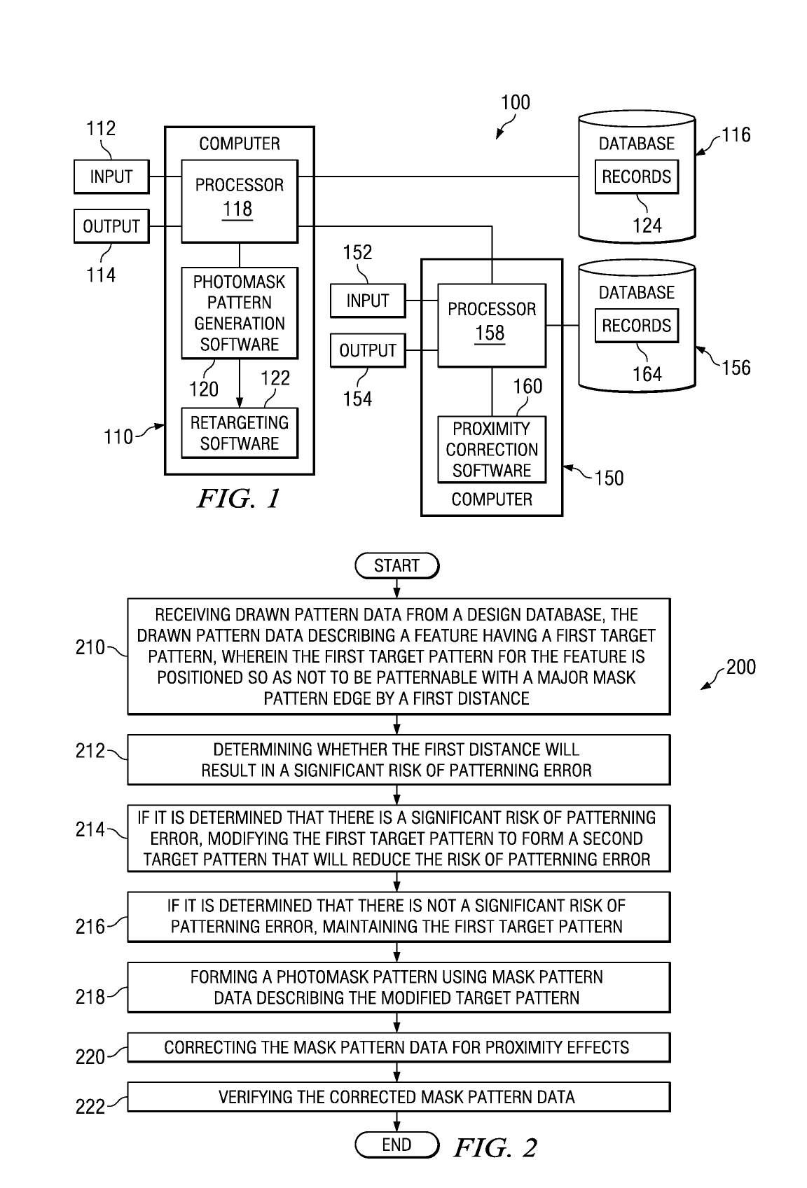

FIG. 1 illustrates a system 100 for forming a photomask pattern, according to an embodiment of the present disclosure. System 100 includes a first computer 110 and a second computer 150. Input devices 112, 152 and output devices 114, 154 are respectively coupled to computers 110 and 150, which are in turn respectively coupled to databases 116, 156, as shown in FIG. 1. Input devices 112, 152 may comprise, for example, a keyboard, a mouse, a network and/or any other device suitable for inputting and manipulating data to the respective computers 110 and 150. Output devices 114, 154 may comprise, for example, a display, a printer, and/or any other device suitable for presenting data from the respective computers 110 and 150.

Computers 110 and 150 can be personal computers, workstations, networked computers, or any other suitable processing platform. Computers 110 and 150 may include processors 118, 158, as shown in FIG. 1. The processor 118, 158 can be implemented using at least one microprocessor from vendors such as Intel, Advanced Micro Devices, Transmeta, IBM, or other circuit manufacturers. In addition, computer 110 can include a photomask pattern generation software 120 and a retargeting software 122. Computer 150 can include a proximity correction software 160.

Photomask pattern generation software 120, retargeting software 122 and proximity correction software 160 can exist as software that comprises program instructions in source code, object code, executable code or other formats; program instructions implemented in firmware; or hardware description language (HDL) files. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes.

Processor 118 can be configured to control the flow of data between input device 112, output device 114, database 116, photomask pattern generation software 120 and retargeting software 122. Photomask pattern generation software 120 and/or retargeting software 122 may receive descriptions of integrated circuit device features from database 116. Database 116 can include drawn pattern data describing device features, including gate features having target patterns. Photomask pattern generation software 120 can form photomask patterns that include gate feature patterns from the drawn pattern data. Retargeting software 122 can be employed to retarget one or more of the gate feature patterns to have second target patterns that are different from the first target patterns.

After the initial mask patterns are prepared, processor 118 can transfer the mask pattern data describing the mask patterns to computer 150 for further processing. The computers 110, 150 can be coupled together over a network (not shown). The network can be a local area network, a wide area network or a combination thereof. The communication protocol between the computers 110, 150 can be implemented with IEEE802.x, token ring, or any other network protocol.

Processor 158 of computer 150 can be configured to control the flow of data between input device 152, output device 154, database 156, and proximity correction software 160. Proximity correction software 160 can be configured to process the mask pattern data received from computer 150. Specifically, proximity correction software 160 performs a proximity correction process that corrects the mask pattern data for proximity effects.

Databases 116, 156 may comprise any suitable system for storing data. Databases 116, 156 can be implemented using mask database technologies employing file formats such as GDSII or Oasis or any other suitable database formats. Database 116 can store records 124 (data or files) that comprise data associated with the integrated circuit device features and the photomask patterns to be generated, such as data from a design database and mask pattern database, as will be described in greater detail below. Database 156 may store records 164 (data or files) that comprise data associated with the proximity correction process, such as, for example, the mask pattern data transferred from computer 110.

FIG. 2 illustrates a flow diagram 200 of a process for making photomasks according to an embodiment of the present disclosure. It should be readily apparent to those of ordinary skill in the art that the flow diagram 200 depicted in FIG. 2 represents a generalized schematic illustration and that other steps may be added or existing steps may be removed or modified.

As shown in block 210 of FIG. 2, the process can include receiving drawn pattern data from a design database. The drawn pattern data can describe drawn patterns of a plurality of device features for forming an integrated circuit. The term “feature”, as used herein, can be broadly interpreted as referring to an element of a semiconductor device. Examples of a feature can include a gate, a gate bus, a well, an isolation structure, an interconnect line, a space, a contact hole, a pillar, a resistor, a dummy feature, a ghost feature, or any other element of a semiconductor device or other device as will be understood by one of ordinary skill in the art.

The terms ghost feature and dummy feature are generally well known in the art, and includes features formed on a substrate that are not considered a functional part of the circuit. A difference between ghost features and dummy features is that ghost features are formed on the wafer and then subsequently removed, while at least a portion of the dummy features remain on the finished wafer. These non-functional structures can be used, for example, to improve critical dimension control when forming semiconductor devices by removing or minimizing the differences in OPC and responses to process variations. For example, a dummy or ghost gate feature can be formed at the end of an array of gates so that the environment of the gates at the end of the array of gates is similar to the environment of the gates in the interior of the array of gates during lithography and/or etching processes, thereby reducing the critical dimension variation for the gates at the end of the array.

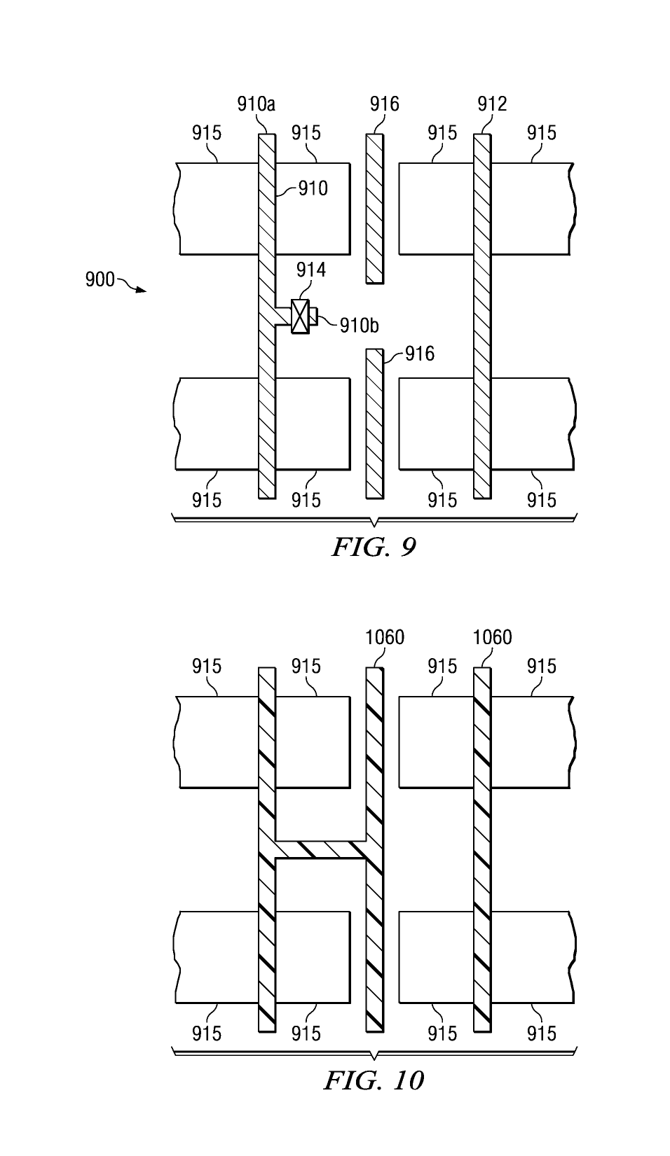

In embodiments of the present disclosure, the drawn pattern data will include data describing one or more features, as discussed above. These features can include gate end features, which can be broadly interpreted as referring to, for example, a gate end or a conductive extension of a gate structure having an end, such as is often used for making electrical contact between a gate and another conductive layer, such as metal 1, metal 2, and upper metallization structures. An example of a gate extension will be described below with reference to FIGS. 9-12. The features can also include metallization patterns (e.g., metal 1 or metal 2 and upper metallization structures) formed adjacent to each that have end portions that do not align so as to be patternable with a major mask pattern edge and for which the lithography can be improved using the concepts of the present application.

In embodiments, the drawn pattern data describing the gate features can include a first target pattern for a gate feature end that is positioned so as not to be patternable with a major mask pattern edge by a first distance, which is the distance between the target gate feature end and the major mask pattern edge that can potentially be used to pattern that gate feature end. Instead, to implement the pattern data as drawn, the mask pattern would include a minor mask pattern edge. The phrase, “major mask pattern edge” is defined herein to mean any straight mask pattern edge segment that is significantly longer than a minor mask pattern edge that is proximate to, and running parallel with, the major mask pattern edge.

The mask makers use the design data from the design database to make one or more photomask patterns for implementing the integrated circuit design described in the design database. This mask making process may generally include a retargeting process that can be carried out, for example, by retargeting software 122 of FIG. 1. As indicated in blocks 212 to 216 of FIG. 2, the retargeting process can include determining whether a first distance between a proposed target gate end and a major mask pattern edge will result in a significant risk of patterning error. As seen at 214 of FIG. 2, if it is determined that there is a significant risk of patterning error, the retargeting process can be employed to modify the first target pattern to form a second target pattern that will reduce the risk of patterning error. In some embodiments, as indicated at 216, if it is determined that there is not a significant risk of patterning error, the first target pattern can remain the same, if desired.

The term “target pattern” is defined herein as a desired shape of the pattern to be formed on the substrate (e.g., the wafer in semiconductor processing). As one of ordinary skill in the art would readily understand, the target pattern is not necessarily identical to the pattern formed on the photomask, or for that matter, the pattern that is actually realized on the substrate. Differences between the target patterns and the photomask patterns can be due, at least in part, to various changes made to the mask pattern during processing, such as optical proximity corrections, which allow the target pattern to be more closely achieved on the substrate, as described herein. Differences between the target patterns and the patterns finally formed on the wafer can be due to various photolithographic and etching process imperfections, for example.

In an embodiment, as shown at 218, the photomask patterns can be formed using the target patterns from the drawn pattern, as they are modified by the retargeting software 122. The photomask patterns may be formed by employing various resolution enhancement techniques, which can be programmed into the photomask pattern generation software 120 and executed by the processor 118.

In addition to retargeting the gate feature ends, some embodiments of the present disclosure can include employing resolution enhancement techniques that involve redrawing portions of the drawn pattern other than the gate features, such as contacts, dummy features or ghost features. For example, in some instances it may be determined that the drawn pattern may be difficult or impossible to pattern given the constraints of the lithography system being employed. In such instances, it may be desirable to redraw the design data pattern to account for these lithography restraints, while still achieving the basic circuit functionality intended by the drawn pattern. Such retargeting of the drawn pattern can occur at any suitable time in the process, including during the initial generation of the photomask patterns or during the proximity correction process. Examples of redrawing the portions of the drawn pattern other than the ghost features can be found in co-pending U.S. patent application No. [Attorney Docket No. 0025.0096 (TI-62656)] and U.S. patent application Ser. No. 11/937,166, entitled TREATMENT OF TRIM PHOTOMASK DATA FOR ALTERNATING PHASE SHIFT LITHOGRAPHY, filed on Nov. 8, 2007, in the name of Carl A Vickery, et al., the disclosures of both of which applications are herein incorporated by reference in their entirety.

Other resolution enhancement techniques that may be employed include splitting the drawn pattern so that it is patterned using two or more photomasks, such as a phase shift mask and a trim mask for use in a phase shift process (altPSM), as mentioned above. Methods for forming phase and trim patterns from design data are well known in the art, and any suitable method for forming such masks may be employed. In an embodiment, the phase and trim patterns are generated using software programs designed to read data from the design database and prepare appropriate patterns for forming the masks. One example of a suitable software program is IN-PHASE, which is available from SYNOPSYS, Inc., having corporate headquarters located in Mountain View, Calif.

Yet another example of resolution enhancement techniques for forming the initial photomask patterns may include the formation of sub-resolution assist features (SRAFs). Techniques for forming SRAFs are well known in the art.

In order to more closely achieve the desired mask target pattern, the initial photomask pattern shown at 218 of FIG. 2 is corrected for proximity effects in a proximity correction process, such as is shown at 220. The proximity correction process generally involves implementing proximity correction software that performs calculations that alter the shape of the photomask pattern to take into account proximity effects, such as optical diffraction effects that occur during the imaging process. Any suitable technique for correcting for proximity effects may be employed. One example of a known proximity correction process is disclosed in U.S. Pat. No. 6,764,795, issued on Jul. 20, 2004 to Aton et al., the disclosure of which is herein incorporated by reference in its entirety.

After correction of the initial photomask pattern for optical proximity effects at 220, the mask pattern data can be put through a verification process 222 to insure that it meets desired quality standards, and is otherwise prepared for manufacturing, or writing, of the photomask.

As part of the verification process, the masks patterns that are generated are checked against the desired target pattern for the circuit layout. The target pattern will generally include the drawn pattern plus any modifications made to the drawn pattern during the mask making process. Thus, in embodiments of the present disclosure, data with modifications to the target patterns, including modifications to gate end target patterns, can be forwarded to a verification data base to be used in the verification process.

Once the preparation of the mask data is complete, the data can then be used to write the photomasks. Often the mask pattern data is sent to a mask shop, where actual production of the photomasks occurs. Any suitable technique for writing the photomask may be employed. Suitable techniques for writing masks are well known in the art.

The steps of flow chart 200 can be performed in any suitable order on either a single computer or on different computers. In one embodiment, steps 210 to 218 can be performed on one computer and performing the proximity correction process of step 200 can be performed on a separate computer. In another embodiment, the entire process of flowchart 200, including proximity correction, can be performed on the same computer.

The process of FIG. 2 may be employed for making any suitable type of photomasks. Examples of such photomasks include alternating phase shift masks, binary masks, embedded attenuated phase shift masks, hard phase shift masks, double-dipole exposure masks, or any other suitable type of mask.

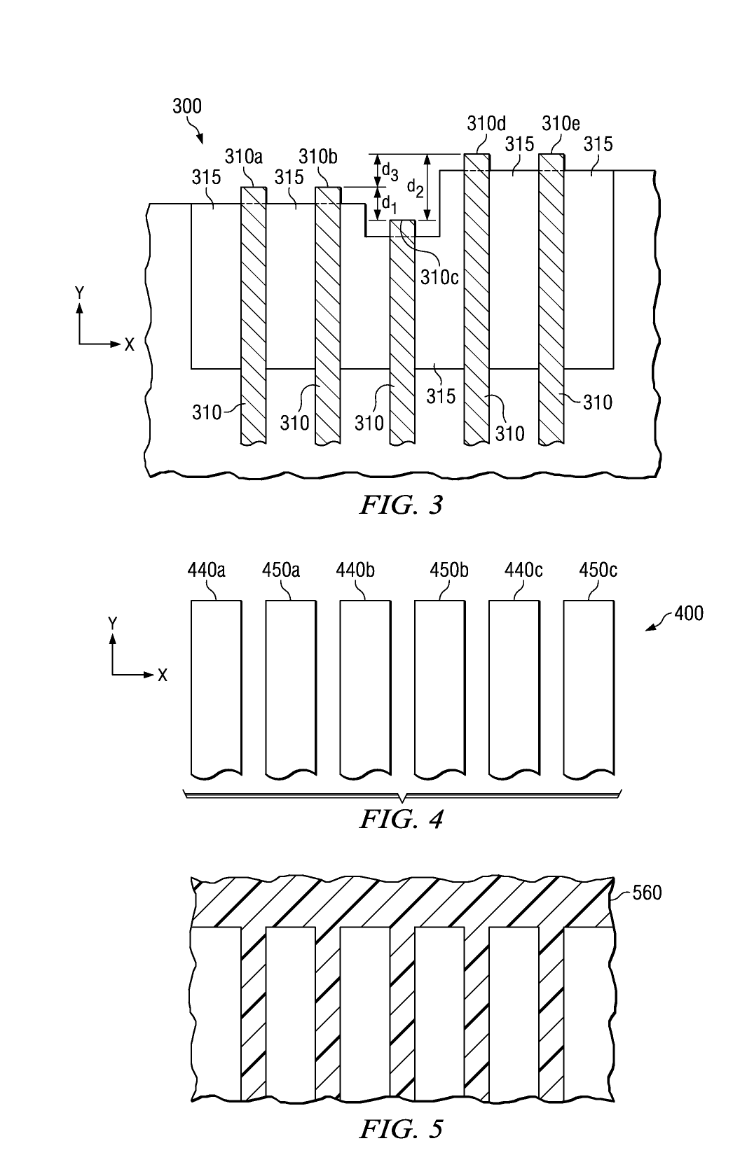

FIG. 3 illustrates one example of drawn pattern data for a drawn circuit layout 300 for a gate level pattern, according to an embodiment of the present disclosure. The drawn pattern data includes gate feature patterns 310 formed over active region patterns 315. Gate feature patterns include gate ends 310a to 310e. For ease of illustration, only one end of the gate feature patterns 310 are shown in FIG. 3. The drawn pattern can be the desired target pattern for some of the gate features. However, as will be described in greater detail below, the first target pattern provided by the drawn pattern for at least some of the drawn gate ends can be altered to provide a second target pattern.

The positions of the drawn gate ends 310a to 310e can vary relative to each other along a y-axis, as illustrated. For example, drawn gate ends 310a and 310b can both be positioned a distance, d₁, further along the y-axis than gate end 310c; and drawn gate ends 310d and 310e can both be positioned a distance, d₂, further along the y-axis than gate end 310c. In one embodiment, d₂ is greater than d₁. Relative positions of drawn gate ends 310a to 310e in FIG. 3 are for illustrative purposes only, and can vary in any desired manner. For example, d₂ can be less than d₁, or, in another example, d₁ can be equal to d₂.

FIG. 4 depicts a top view of an exemplary photomask pattern 400, which may be used in conjunction with a second photomask pattern, discussed below, for implementing the drawn pattern of FIG. 3. In an embodiment, mask pattern 400, as illustrated, is an alternating phase shift pattern. However, the mask pattern is not limited to a phase mask pattern, and one of ordinary skill in the art would readily understand how to apply the principles of the present application to other types of masks suitable for use in multi-pattern processing, including embedded attenuating phase shift masks, binary masks and dipole masks can be used.

As is well known in the art, phase shift mask pattern 400 can include alternating patterns for clear 0 degree phase areas 440 and clear 180 degree phase areas 450. Generally, 0 degree phase areas 440 are disposed adjacent to 180 degree phase areas 450 on a phase mask. These clear phase shift areas allow light to pass through such that destructive interference occurs at the boundary between the areas. For example, 180 degree phase areas 450 can have a thickness so that it creates destructive interference at its boundary with 0 degree phase areas 440, as is well known in the art. Generally speaking, techniques for forming alternating phase shift masks are well known in the art.

In an embodiment, as shown in FIG. 4, the ends of the phase patterns 440a and 450a are aligned so as to be positioned at substantially the same location along an y-axis. For example, the position of the ends of the phase patterns along the y-axis can be based upon the gate ends in the drawn pattern that extend the furthest on the y-axis, which in FIG. 3 are gate ends 310d and 310e. Thus, in one exemplary embodiment, the phase pattern ends 440a-c and 450a-c can be positioned to extend a desired distance past gate ends 310d and 310e. In other embodiments, phase pattern ends can be positioned at different locations along the y-axis, such as, for example, positioning 440a, 450a, and 440b at a different y-axis position than phase pattern ends 450b, 440c, and 450c.

As described above, a second photomask pattern is used in conjunction with photomask pattern 400 to implement the drawn pattern. The general function of the second mask, sometimes referred to herein as a “trim mask,” is to pattern, or trim, the pattern formed by the photomask pattern 400 during wafer processing in order to form the edges of the drawn pattern that are not formed by the photomask pattern 400. The second photomask pattern can be for forming any type of mask suitable for use in multi-pattern processing, including, for example, alternating phase shift masks, embedded attenuating phase shift masks, binary masks and dipole masks.

The general shape of the second photomask pattern can be determined from the drawn pattern. In embodiments of the present disclosure, the shape of the second photomask pattern can also be determined, at least in part, during a retargeting process, in which the drawn pattern can be altered for lithographic purposes. More specifically, the retargeting process can include determining whether a first distance between an edge of the drawn pattern and a major mask pattern edge will result in a significant risk of patterning error. If it is determined that there is not a significant risk of patterning error, it may be determined that no modifications of the drawn pattern art to be made. However, if it is determined that there is a significant risk of patterning error, the drawn pattern can be altered to reduce that risk.

A potential trim mask pattern 670 for implementing the drawn pattern 300 is illustrated in FIG. 6a. The trim mask pattern is shown overlying drawn pattern 300. Trim mask pattern 670 includes a first major edge 672, for patterning the gate ends 310a and 310b. A minor, “notched” edge is used for patterning gate end 310c. A second major edge 676 is used for patterning the gate ends 310d and 310e.

It has been determined that notched edges in the trim pattern can result in a significant risk of patterning error. This may be partly due to the limited spatial bandwidth of current lithographic systems, and the associated inability to form the pattern as drawn. The narrower and deeper the notch is, the more difficult it can be to successfully implement on the substrate during device fabrication. Incorrectly patterning such notches can result in incorrect patterning of gates proximate to the notch, which may in turn result in decreased circuit performance. Thus, it may be desirable to reduce the risk of pattern error when forming such notches.

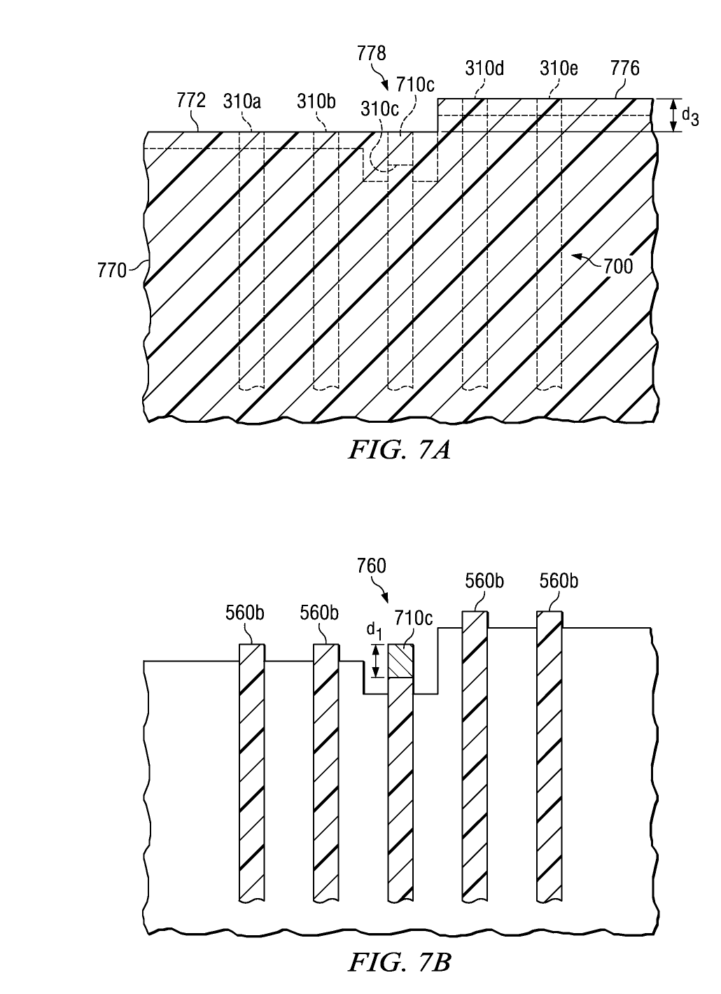

If it is determined that there is a significant risk of patterning error, the software employed by, for example, retargeting software 122, can modify the first target pattern of the drawn pattern data to form a second target pattern that will reduce the risk of patterning error. FIG. 7A illustrates an embodiment showing a trim mask pattern 770 that is based on a modified target pattern. Trim mask pattern 770 is shown overlying a modified target pattern 700, which is similar to the drawn pattern 300, except that gate end 310c has been repositioned to align with gate ends 310a and 310b, as shown by 710c of FIG. 7A. This allows the gate ends 310a, 310b and 710c to be patterned using a first major edge 772 of the trim mask, and eliminates the notched edge 674 that was present in the trim pattern 670 of FIG. 6.

Removing the notched edge 674 increases the ease of printing the pattern 770 relative to pattern 670, and thus may reduce the risk of patterning errors that might compromise circuit function. However, trim pattern 770 still includes a step 778 in the pattern edge, resulting in a first distance, d₃, between gate ends 310a, 310b, 310c and gate ends 310d, 310e. The existence of step 778 can present a risk of patterning error. Accordingly, in an embodiment of the present disclosure, trim pattern 770 can be checked to determine whether there is a significant risk of patterning error.

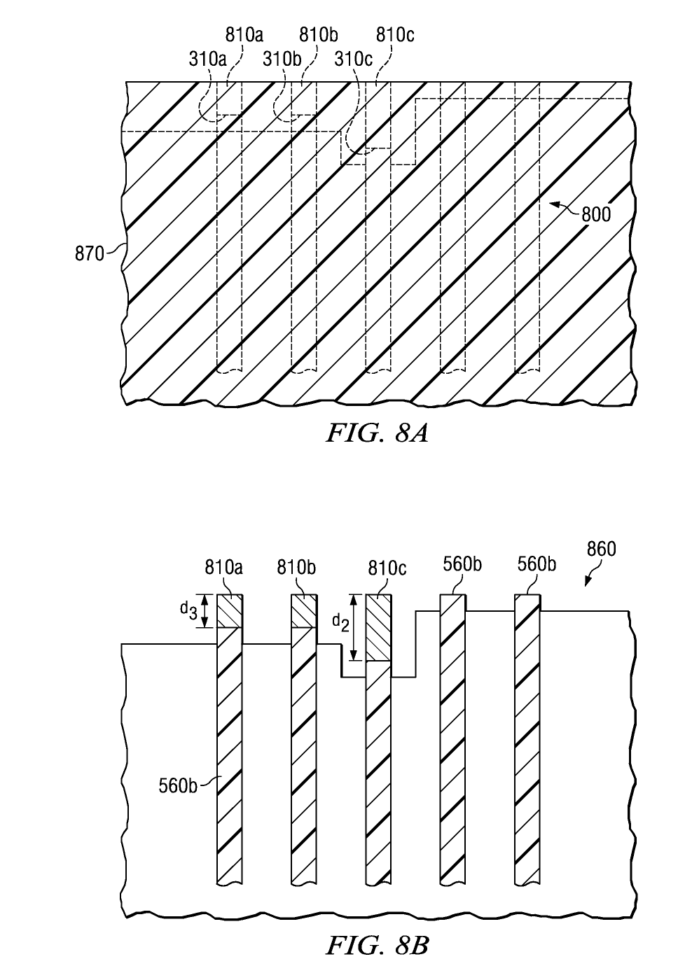

If it is determined that there is a significant risk of patterning error for trim mask pattern 770, the software employed by the retargeting software can modify the target pattern 700 to form a third target pattern 800 that can further reduce the risk of patterning error. FIG. 8A illustrates an embodiment showing a trim mask pattern 870 that is based on the third target pattern. Mask pattern 870 is shown overlying the modified target pattern 800. Target pattern 800 is similar to drawn pattern 300, except that gate ends 310a, 310b and 310c have been repositioned to align with gate ends 310d and 310e, as indicated by the hatched regions showing new gate end positions 810a, 810b and 810c. This allows the gate ends 310a, 310b and 310c to be patterned using the same major edge 772 of the trim mask that is used to pattern gate ends 310d and 310e, and eliminates the step 778 that was present in the trim mask pattern 770 of FIG. 7.

Determining which of the potential trim mask patterns 670, 770 and 870 to employ can depend on a number of factors. Such factors can include, for example, the increased capacitance that may be caused by extending gate ends and the associated impact on circuit performance; as well as the difficulty of patterning the notched edge pattern 674 or step pattern 778, and the associated risk of patterning error. For example, referring to FIG. 3, the greater the misalignment, d₁ and/or d₂, between adjacent gate ends of drawn pattern 300, the more difficult the notched edge pattern 300 will be to print within acceptable tolerances. If d₁ and/or d₂ are too great, attempting to print the pattern can result in printing errors, which may compromise gate ends 310b and/or 310d that are positioned adjacent to gate end 310c. For example, gate ends 310b and/or 310d might be printed shorter than specified in the drawn pattern 300, which can potentially result in increased leakage current.

The values for d₁ and d₂ can literally be chosen to be any desired value. Non-limiting exemplary values for d₁ and/or d₂ can range from 0 to about 1 micron. In some embodiments, d₁ and/or d₂ are at least 2 nm, such as at least 5 nm, 50 nm, or more. The values chosen for d₁ and d₂ can vary depending on various parameters. In an “typical” exemplary semiconductor process, where the channel length of CMOS transistors is about 40 nm and the gate-to-gate pitch is about 170 nm, the values of d₁ and d2 might, for example, be locked to a 5 nm drawing grid for the gates, thus taking on values varying in increments of 5 nm (e.g., 0 nm, 5 nm, 10 nm, . . . up to the largest value of use in the design, perhaps somewhere around 1000 nm). If the process employs a 2 nm drawing grid, d₁ and d₂ might instead take on values varying in increments of 2 nm (e.g., 0 nm, 2 nm, 4 nm, . . . up to the largest value used in the design). As would be readily understood by one of ordinary skill in the art, useful values of d₁ and d₂ will typically scale with the overall dimensions of the features drawn in the design database when moving from one generation of semiconductor devices to the next. Such scaling has historically been by about 0.7 between each new generation of semiconductor devices.

The dimensions disclosed for d₁ and d₂, as well as any other pattern dimensions disclosed herein unless otherwise expressly stated, are based upon the size of the pattern to be formed on the wafer. The actual dimensions for d₁ and d₂ for the photomask patterns will vary depending upon the size of the reduction factor of the photomask. As discussed above, photomasks are often formed to have, for example, a 4× or 5× reduction factor, meaning that the photomask pattern dimensions can be about 4 or 5 times larger than the corresponding dimensions formed on the wafer. Similarly, the dimensions of the drawn pattern may or may not also have a reduction factor. Therefore, as one of ordinary skill in the art would readily understand, the mask sizes and the drawn pattern sizes can correspond to the wafer dimensions based on any suitable reduction factor, including where the dimensions on the mask and/or drawn pattern dimensions are intended to be the same as those formed on the wafer.

Any suitable method can be employed for determining which of the trim mask patterns 670, 770 and 870 can be used. For example, a set of mask rules can be implemented by the retargeting software for determining whether the drawn pattern is to be implemented or modified if a certain set of conditions are met; and if modified, how the drawn pattern can be modified. Conditions to be met could, for example, be based on: electrical behavior, such as the amount of capacitance being added to a given electrical node of the circuit; the alignment capability between patterning layers of the lithography tool, the spatial patterning bandwidth of the lithography tool and/or any other suitable and useful criteria.

In one illustrative embodiment, the retargeting software may be programmed to recognize the notched drawn pattern scenario illustrated in FIG. 3, and determine the appropriate mask pattern to implement based on the degree of misalignment between the ends of the target patterns, as indicated by d₁ and/or d₂. Thus, if a first set of conditions may be met where d₁ and/or d₂ are very small, it may be determined beforehand that the degree of increased capacitance associated with the small misalignment between the target patterns is insignificant to circuit function; and therefore the target pattern can be redrawn so as to allow patterning of the gate ends with a single major mask pattern edge, similarly as shown in the example of FIG. 8A. If, on the other hand, a second set of conditions are met where d₁ and/or d₂ are so large as to indicate that the drawn pattern cannot be patterned without creating an unacceptable risk of increasing leakage current, then it may be determined that the drawn pattern is to be modified, If so, it may be determined that a trim mask pattern with a stepped edge, as in the embodiment of FIG. 7A, will reduce the risk of leakage current to acceptable levels. If however, the FIG. 7A embodiment will not reduce the risk of leakage current to acceptable levels, then a mask pattern according to the embodiment of FIG. 8A can be implemented.

It may be decided that a third set of conditions can exist where d₁ and/or d₁ are not so small as to insignificantly increase capacitance, but are not so large as to unacceptably increase the risk of leakage current. For drawn patterns where this third set of conditions is found to exist, it may be determined, for example, that the drawn pattern is to be printed using a trim mask pattern, such as the embodiment shown in FIG. 6A. Or alternatively, if this third set of conditions are met, it may be determined that the drawn pattern is to be printed only if the embodiments of FIG. 7A or 8A do not provide a more optimum solution, based on factors such as capacitance and lithographic patternability.

In some embodiments, the appropriate pattern to be used can be determined based on computer modeling and/or simulation software that can determine the potential effects on circuit function of potential modifications to the drawn pattern, including the risks of patterning errors, increased leakage current, and increased capacitance. Based upon these factors, the software can be programmed to determine, for example, which of embodiments 6A, 7A and 8A provide an appropriate mask pattern solution.

The phase and trim patterns illustrated in FIGS. 4, 6A, 7A and 8A can be used to make phase and trim masks for use in a two-print/two-etch (2p/2e) process in which the phase exposure and trim exposure are each performed on separate photoresists. The patterns from each of the photoresists can be individually transferred to, for example, a first layer formed on a substrate.

FIG. 13 illustrates an embodiment of a 2p/2e process. As illustrated at 1310 of FIG. 13, a first layer is formed on a substrate. The first layer can be a hardmask formed on a device layer, such as, for example, a layer including doped polysilicon and/or metal, in which the device feature to be patterned is formed. Exemplary hardmask materials can include silicon oxynitride, silicon nitride, and silicon oxide. In an alternative embodiment, a hardmask is not employed and the first layer is the device layer.

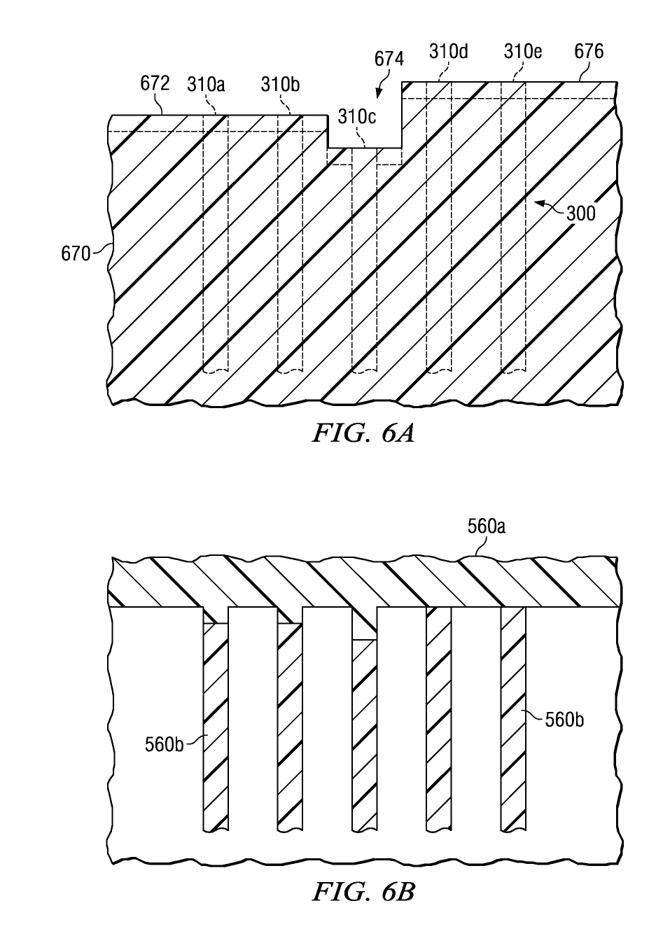

A first photoresist is formed over the first layer, and a first photomask exposure can be employed to transfer, for example phase pattern 400, to the first photoresist, similarly as shown at 1320. The resulting first photoresist pattern can then be transferred to the first layer using any suitable etching techniques. The remaining first photoresist pattern can then be removed, as shown at 1330. FIG. 5 illustrates an embodiment of a hardmask 560 with phase pattern 400 formed therein.

A second photoresist can then be formed over the first patterned layer, similarly as shown at 1340 of FIG. 13. A trim mask pattern is transferred to the second photoresist. Any of trim mask patterns illustrated in FIGS. 6A, 7A and 8A, can be employed to image a pattern in the second photoresist. This can be accomplished by aligning, for example, trim mask pattern 670 over the hard mask pattern 560 of FIG. 5 and exposing the second photoresist to radiation through the trim mask. The imaged photoresist can then be developed to form the desired pattern in the photoresist.

The resulting second photoresist pattern is then transferred to the first layer using a second etching step, as shown at 1350 of FIG. 13. For example, an etching process can be used to remove a portion of the hardmask pattern 560, such as, for example, portion 560a (shown in the embodiment of FIG. 6B), using the second photoresist pattern as a mask. A portion 560b of the hardmask remains and is used as a mask for etching the substrate to form a device pattern, which, in the embodiment of FIG. 6B, is substantially similar to the drawn pattern 300, shown in FIG. 3.

For situations where it is determined that the trim mask pattern of FIG. 6A for forming the drawn pattern presents a significant risk of patterning error, trim mask patterns 770 and 870 can also be employed in the second photomask. Thus, a single photomask can include mask patterns similar to those of FIGS. 6A, 7A and 8A for patterning different device patterns of the drawn pattern. Where the pattern of FIG. 7A is employed, an etching process is used to form, for example, a hardmask pattern 760 that is substantially similar to the modified target pattern 700. Hardmask pattern 760 includes gate end 710c, which has been extended approximately a distance d₁ relative to the drawn pattern 300. Where the pattern of FIG. 8A is employed, the etching process is used to form, for example, a hardmask pattern 860 that is substantially similar to the modified target pattern 800. Hardmask pattern 860 includes gate ends 810a, 810b, which have been extended approximately a distance d₃ relative to the drawn pattern; and 810c, which has been extended approximately a distance d₂ relative to the drawn pattern 300.

Subsequently, the hardmask pattern, having both the first photomask pattern and trim pattern etched therein, is used to etch the substrate using etching techniques that are well known in the art. In processes that do not employ a hardmask, the first photomask pattern and trim pattern can be transferred directly to the device layer using the first photomask and trim patterning processes described above with reference to steps 1330 and 1350 in the embodiment of FIG. 13.

FIGS. 9 to 12B illustrate another embodiment of the present disclosure. FIG. 9 shows an embodiment of a drawn pattern for a gate level circuit layout 900. Circuit layout 900 includes gate feature patterns 910 and 912 formed over active region patterns 915. Gate feature pattern 910 includes a gate end 910a and a gate contact extension 910b. Gate contact extension 910b is formed to allow a contact 914 to electrically contact gate feature pattern 910, as is well known in the art. The drawn pattern also includes electrically non-functional features 916, which can be ghost features or dummy features, which are formed for lithographic purposes. In the embodiment illustrated, features 916 are “ghost features” that are to be removed by the trim mask. However, in other embodiments, the dummy features may remain on the substrate. An example of a process employing dummy features is further described in copending Unites States patent application No. [TI-62651 (attorney docket no. 0025.0091)], the disclosure of which is herein incorporated by reference in its entirety.

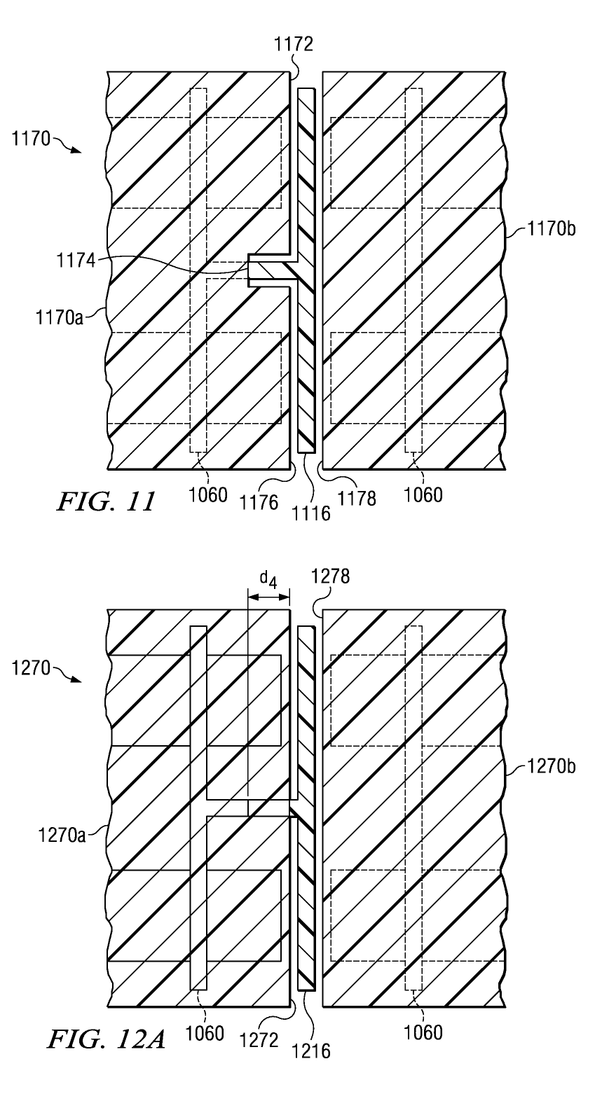

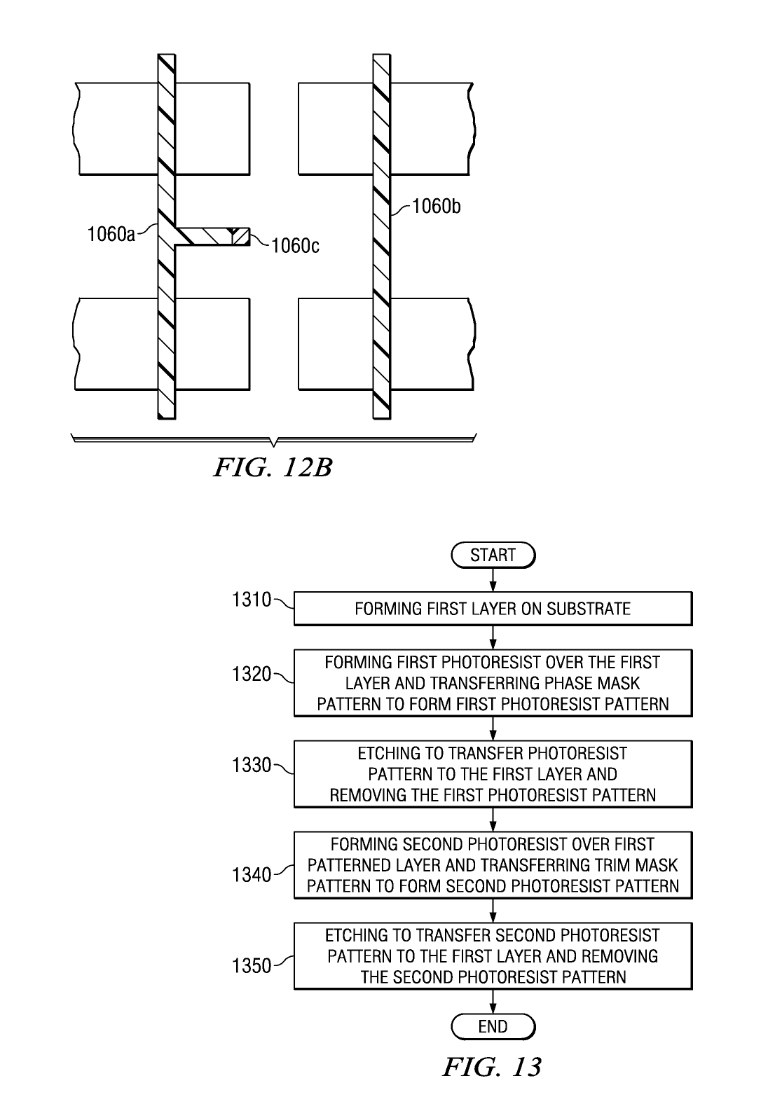

The mask pattern forming process for implementing the drawn pattern can include forming a first photomask pattern (not shown), similarly as described above. FIG. 10 illustrates a hardmask pattern 1060 that can be formed using a first photomask having the first photomask pattern, according to an embodiment of the present disclosure. The first photomask can be employed in conjunction with a trim mask in a two-pattern/two-etch (2p/2e) process in which the first photomask exposure and trim exposure are each performed on separate photoresists, similarly as described above. Two different trim mask patterns that can potentially be used in this embodiment are illustrated in FIGS. 11 and 12a. Similarly as described above, the shape of the trim mask used can be determined, at least in part, during a retargeting process performed, for example, by retargeting software 122.

FIG. 11 illustrates a trim pattern 1170, including trim pattern regions 1170a and 1170b overlying hardmask pattern 1060 of FIG. 10. Trim mask pattern 1170 is formed to cover portions of the hardmask pattern 1060 that are to remain. Trim pattern 1170a includes major edges 1172 and 1176, and a minor edge 1174. Trim pattern 1170b includes a major edge 1178. The portion 1116 of the hardmask phase pattern 1060 that lies between the edges of trim patterns 1170a and 1170b, shown by the hatched region, is to be removed by the photolithography and etching processes associated with the trim mask. The remaining portion of hard mask 1060 is used as a mask for etching the substrate to form a pattern substantially similar to the drawn pattern 900, shown in FIG. 9, except ghost features 916 have been removed.

If it is determined that trim mask 1170 presents a significant risk of patterning error, the software employed by, for example, retargeting software 122, can modify the drawn pattern to form a second target pattern that can reduce the risk of patterning error. For example, drawn pattern 900 of FIG. 9 can be modified by extending the gate contact extension 910b by a distance d₄, as shown in FIG. 12A. This allows the end of modified gate contact extension 910b to be patterned using a single major edge 1272 for removing the ghost features, in place of major edges 1172 and 1176, and minor edge 1174, of the trim mask in FIG. 11. Thus, the trim mask pattern 1270 effectively results in the removal of the notched edge 1174 of the FIG. 11 pattern, and increases the likelihood that the trim pattern can be successfully printed.

The portion 1216 of the hardmask phase pattern that lies between the edges of trim patterns 1270a and 1270b, shown by the hatched region, is to be removed by photolithography and etching processes associated with the trim mask. The remaining portion of hard mask 1060, shown in FIG. 12B, is substantially similar to the drawn pattern for gate features 910 and 912, shown in FIG. 9, except that the length of gate contact extension 910b has been extended.

Determining which of the trim mask patterns 1170 or 1270 to employ can depend on a number of factors, such as increased capacitance, the difficulty of patterning the notched edge pattern of FIG. 11 and any associated detrimental effects to the circuit, as described above. For example, patterning error in this instance might result in gate contact extension 910b being formed too short, which may compromise the ability to form contact 914 in contact with gate feature 910. Any suitable method can be employed for determining which of the trim mask patterns 1170 or 1270 can be used, similarly as described above.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

It is noted that, as used in this specification and the appended claims, the singular forms “a,” “an,” and “the,” include plural referents unless expressly and unequivocally limited to one referent. Thus, for example, reference to “an acid” includes two or more different acids. As used herein, the term “include” and its grammatical variants are intended to be non-limiting, such that recitation of items in a list is not to the exclusion of other like items that can be substituted or added to the listed items.

While particular embodiments have been described, alternatives, modifications, variations, improvements, and substantial equivalents that are or can be presently unforeseen can arise to applicants or others skilled in the art. Accordingly, the appended claims as filed and as they can be amended are intended to embrace all such alternatives, modifications variations, improvements, and substantial equivalents.

What is claimed is:

1. A method for preparing photomask patterns, the method comprising:
receiving drawn pattern data from a design database, the drawn pattern data describing a feature having a first target pattern, wherein the first target pattern for the feature is positioned so as not to be patternable with a major mask pattern edge by a first distance;
determining whether the first distance will result in a significant risk of patterning error;
if it is determined that there is a significant risk of patterning error, modifying the first target pattern to form a second target pattern that will reduce the risk of patterning error; and
if it is determined that there is not a significant risk of patterning error, maintaining the first target pattern.

2. The method of claim 1, wherein the feature is a gate end.

3. The method of claim 2, wherein the gate end is positioned adjacent to a second gate end having a third target pattern in the drawn pattern data, the third target pattern being positioned so as to be patternable with the major mask pattern edge.

4. The method of claim 2, wherein determining whether the first distance will result in a significant risk of patterning error comprises comparing the relative positions of the first target pattern and the third target pattern to calculate the first distance.

5. The method of claim 4, wherein forming the second target pattern comprises modifying the first target pattern to align with the third pattern, so that both the first and second target patterns can be patterned with the major mask pattern edge.

6. The method of claim 2, further comprising a third gate end positioned adjacent to the first gate end, wherein a fourth target pattern for the third gate end does not align with either the first target pattern or the third target pattern, and wherein the major mask pattern is determined based on the fourth target pattern.

7. The method of claim 6, wherein both the first target pattern and the third target pattern are modified so as to be patternable with the major mask pattern edge.

8. The method of claim 1, wherein forming the second target pattern comprises modifying the first target pattern so as to be patternable with the major mask pattern edge.

9. The method of claim 8, wherein data regarding the modification of the first target is forwarded to a post verification data base.

10. The method of claim 1, wherein the gate feature end is the end of a gate contact extension and the major mask pattern edge is a trim mask edge, and further wherein the first target pattern for the gate feature end is not patternable with the trim channel edge.

11. The method of claim 10, wherein the first target pattern is retargeted so as to be patternable with the trim channel edge.

12. The method of claim 1, wherein the major mask pattern edge is a trim pattern edge.

13. The method of claim 1, wherein the major mask pattern edge is a phase pattern edge.

14. A computer system for generating a photomask pattern, the system comprising one or more computers comprising a set of computer readable instructions for carrying out the method of claim 1.

15. A multi-pattern process for patterning an integrated circuit device, the process comprising:
providing a substrate,
forming a layer on the substrate;
applying a first photoresist over the layer;
exposing the first photoresist to radiation through a first photomask and developing the first photoresist to form a first pattern;
etching to transfer the first pattern into the layer,
removing the first photoresist;
applying a second photoresist over the layer;
exposing the second photoresist to radiation through a second photomask and developing the second photoresist to form a second pattern;
etching to transfer the second pattern into the layer; and
removing the second photoresist,
wherein at least one of the first and second photomasks are prepared by a method comprising:
receiving drawn pattern data for a design database, the drawn pattern data describing a gate feature end, wherein a first target pattern for the gate feature end is positioned so as not to be patternable with a major mask pattern edge by a first distance; and
modifying the first target pattern to form a second target pattern that will reduce the risk of patterning error.

16. The process of claim 15, wherein the first photomask is a phase mask and the second photomask is a trim mask.

17. The process of claim 15, wherein the first photomask and the second photomask are both embedded attenuated phase shift masks.

18. The process of claim 15, wherein forming the second target pattern comprises modifying the first target pattern so as to be patternable with the major mask pattern edge.

19. A method for preparing a photomask pattern, the method comprising:
receiving drawn pattern data from a design database, the drawn pattern data describing two or more adjacent feature ends that are positioned at different locations along a y-axis;
forming a photomask pattern for patterning the feature ends, wherein the photomask pattern will result in the feature ends being positioned at the same location along the y-axis.

20. The method of claim 19, wherein the feature is a gate end.
